(19) United States
(12) Patent Application Publication
(10) Pub. No.: US 2004/0237841 A1
(43) Pub. Date: Dec. 2, 2004

(54) Nonaqueous spray applied compositions and methods for applying them

(76) Inventors: David W. Brown, Ambler, PA (US); Kenneth Breindel, Lansdale, PA (US); Michael S. Wiggins, Lansdale, PA (US); Ronald W. Broadbent, Horsham, PA (US)

Correspondence Address: COGNIS CORPORATION, PATENT DEPARTMENT, 300 BROOKSIDE AVENUE, AMBLER, PA, 19002, US

(21) Appl. No.: 10/767,534

(22) Filed: Jan. 29, 2004

Related U.S. Application Data
(60) Provisional application No. 60/443,383, filed on Jan. 29, 2003.

(51) Int. Cl. C07G 1/00; C08H 1/00; C09K 3/00; C08K 5/00

(52) U.S. Cl. 106/287.22; 106/287.23; 106/503; 106/499

(57) ABSTRACT

Nonaqueous compositions formulated for spray application to a substrate wherein the composition contains a foam-reducing quantity of at least one base-catalyzed reaction product comprising the following reactants:

A) at least one compound of formula I

R¹(X)₃ (I)

wherein each X group is a halogen atom or one X group is a halogen atom and two X groups represent an epoxy oxygen atom, which is attached to two adjacent carbon atoms in the R¹ group to form an epoxy group, and R¹ is an alkanetriyl group containing from 3 to 10 carbon atoms; and

B) at least one compound having the formula II

R²X(AO)ₙY (II)

wherein R² is a substituted or unsubstituted, saturated or unsaturated, organic group having from 1 to 36 carbon atoms; X is —O—, —S—, or —NR³— where R³ is hydrogen or a C₁-C₁₈ alkyl group; each AO group is independently an ethyleneoxy, 1,2-propyleneoxy, or 1,2-butyleneoxy group, n is a number of from 0 to 200; and Y is hydrogen, or Y can be a mercapto group or an amino group or a C₁-C₆ alkylamino group in place of a terminal —OH group, provided that when Y is mercapto or an amino group or a C₁-C₆ alkylamino group, n is at least 1;

wherein the mole ratio of the linking compound A) to B) is from 0.1:1 to 5:1; and methods for their application.

### CROSS-REFERENCE TO RELATED APPLICATIONS

This application claims priority, under 35 U.S.C. §119(e), of U.S. Provisional Patent Application No. 60/443,383, filed on Jan. 29, 2003, the entire contents of which are hereby incorporated by reference.

### FIELD OF THE INVENTION

This invention relates to spray applied nonaqueous coating compositions and to methods for applying them.

### BACKGROUND OF THE INVENTION

Nonaqueous coating composition for spraying onto substrates to be coated with the compositions are of course well known to the art. However, a recurring problem with such coatings is the encapsulation of air during the spraying process, which can lead to uneven coatings, pitted coatings, oxidation problems with substrates sensitive to oxygen, and other similar problems.

Also, additives that are effective in aqueous systems are not always effective in nonaqueous systems. Effective additives, such as defoaming agents for nonaqueous systems are commercially important and are in great demand.

### SUMMARY OF THE INVENTION

This invention relates to nonaqueous compositions for spraying onto substrates to be coated therewith, and to methods for their application.

The nonaqueous compositions formulated to be applied to a substrate by spraying are nonaqueous compositions which are either liquid at room temperature, or which can be liquefied by heating prior to use.

The nonaqueous spray-formulated compositions of the invention contain at least one branched reaction product comprising the following reactants:

A) at least one compound of formula I

R¹(X)₃ (I)

wherein each X group is a halogen atom or one X group is a halogen atom and two X groups represent an epoxy oxygen atom, which is attached to two adjacent carbon atoms in the R¹ group to form an epoxy group, and R¹ is an alkanetriyl group containing from 3 to 10 carbon atoms; and

B) at least one compound having the formula II

R²X(AO)ₙY (II)

wherein R² is a substituted or unsubstituted, saturated or unsaturated, organic group having from 1 to 36 carbon atoms; X is —O—, —S—, or —NR³— where R³ is hydrogen or a C₁-C₁₈ alkyl group; each AO group is independently an ethyleneoxy, 1,2-propyleneoxy, or 1,2-butyleneoxy group, n is a number of from 0 to 200, preferably from 1 to 100, more preferably from 2 to 20; and Y is hydrogen, or Y can be a mercapto group or an amino group (amino or C₁-C₆ alkylamino group) in place of a terminal —OH group, provided that when Y is mercapto or an amino group or a C₁-C₆ alkylamino group, n is at least 1;

wherein the mole ratio of the linking compound A) to B) is from 0.1:1 to 5:1, preferably from 0.6:1 to 2:1, more preferably from 0.8:1 to 2:1, and most preferably from 0.8:1 to 1.5:1.

The presence of the above branched reaction product or products in the nonaqueous spray-formulated compositions of the invention acts as a highly effective defoaming agent. In addition, the branched reaction products of the invention improve wetting of the substrate to be coated, improve the flow and leveling of the coating, improve the gloss of the dried coating where relevant, reduces or eliminates air bubbles in the coatings, and enables the manipulation of the shear viscosity of the spray applied coatings, i.e. the viscosity can be either increased or decreased by selection of the molecular weight and quantity of the above reaction product or products.

### DETAILED DESCRIPTION OF THE INVENTION

Other than in the operating examples, or where otherwise indicated, all numbers expressing quantities of ingredients or reaction conditions used herein are to be understood as modified in all instances by the term “about”.

The nonaqueous spray-formulated composition of the invention contain a defoaming-effective quantity of the above branched reaction product(s), which is typically from 0.001 to 5% by weight, preferably from 0.1 to 3% by weight, based on the weight of the composition.

In the branched reaction products used in the nonaqueous spray-formulated compositions of the invention, the linking compound of formula I in composition A) is preferably epichlorohydrin or another epihalohydrin. However, trihaloalkanes can be used, such as 1,2,3-trichloropropane, 1,2,4-trichlorobutane, 1,3,6-trichlorohexane, and the like. Instead of chlorine in the epihalohydrins and trihaloalkanes, the corresponding bromine and iodine compounds can also be used, including compounds containing two or even all three of the above halogens.

The component B) compounds of formula II are organic (optionally alkoxylated) alcohols or the corresponding sulfhydryl or amine compounds.

The R² group can be a substituted or unsubstituted, saturated or unsaturated hydrocarbon group having from 1 to 36 carbon atoms. Examples of such hydrocarbon groups include linear or branched alkyl groups having from 1 to 36 carbon atoms, preferably from 4 to 22 carbon atoms, linear or branched alkenyl or alkynyl groups having from 2 to 36 carbon atoms, preferably from 4 to 22 carbon atoms, aryl groups having from 6 to 22 carbon atoms, and arenyl groups having from 7 to 36 carbon atoms. Arenyl groups are alkyl-substituted aromatic radicals having a free valence at an alkyl carbon atom such as a benzylic group.

The R² group can also be a saturated carboxylic group, an unsaturated carboxylic group having one or more multiple bonds, a saturated heterocyclic group, an unsaturated heterocyclic group having one or more multiple bonds. Any of the above R² groups can be substituted groups, i.e. the groups can be single or multiple substituents such as a sulfur functionality such as a mercaptan or thio group; a nitrogen functionality such as an amine or amide functionality; an alcohol functionality, a silicon functionality, e.g., a siloxane; an ether functionality, e.g. a C₁-C₆ alkoxy group, or any combination thereof.

The R² group in formula II is preferably a branched chain alkyl group containing from 4 to 36 carbon atoms, preferably from 4 to 12 carbon atoms, and more preferably from 8 to 12 carbon atoms.

When the X group of formula II is an —S— group, the R² group will preferably have from about 4 to about 22 carbon atoms, examples of which include but are not limited to, dodecyl mercapto and 1-hexadecanethio.

When the R²X-group of formula II is a secondary or tertiary amino group, the group preferably contains from 4 to 22 carbon atoms, and n is preferably a number of from 1 to 50. Examples of primary and secondary amines useful for obtaining the R²X-group include, but are not limited to, cyclohexyl amine, isodecyl amine, and dioctylamine.

Optionally an additional component C) can be reacted with the linking agent of formula I and the compound of formula II. A glycidyl ether or amine can be added to the reaction of formula I and formula II. The amount of the glycidyl ether or glycidyl amine is from about 1 to about 20 mole percent based on the moles of the compounds of formula II used in the reaction. When the glycidyl ether or glycidyl amine is added, the ratio of component A) plus the glycidyl ether or glycidyl amine to component B) is preferably from about 1.2:1 to about 5:1. Examples of glycidyl ether include, but are not limited to, PEG 600 diglycidyl ether, TETRONIC™ 701 tetraglycidyl ether, triglycidyl di or triethanolamine, polyoxyethylene (POE) 200 tallow-amine diglycidyl ether, propoxylated (POP 10) trimethylol propane triglycidyl ether, propoxylated (POP7) pentaerythritol tetraglycidyl ether. Examples of glycidyl amines include, but are not limited to, tetraglycidyl 1,6-hexane diamine, tetraglycidyl JEFFAMINE™ EDR-148, and tetraglycidyl isophorone diamine.

When Y in formula II is an amine or sulfhydryl group, the resulting compounds can be readily prepared from the corresponding alcohols wherein the terminal hydroxy group is replaced by an —SH group or by an amine nitrogen. For example, a compound of formula II where Y is —OH can be subjected to a catalyzed ammoniation (with ammonia, or a lower alkylamine) for replacement of the hydroxyl.

In the compounds of formula II, the AO groups when present are preferably all ethyleneoxy groups. However, as stated above, each OA group can be independently an ethyleneoxy (EO), 1,2-propyleneoxy (PO), or 1,2-butyleneoxy (BO) group, i.e. any one or more of such groups can be present, and they can be present in any order, as well as be present in blocks, e.g. compounds of formula III:

R²O(EO)ₘ(PO)ₚ(BO)_{q}H (III)

wherein R² has the meaning given above, m is a number of from 0 to 100, preferably from 1 to 50, p is a number of from 0 to 50, e.g. from 1 to 50, and q is a number of from 0 to 50, e.g. from 1 to 50. Compounds of formula III in which R² is a branched chain alkyl group having from 4 to 12 carbon atoms, m is a number of from 2 to 20, and p and q are 0 are preferred.

The degree of hydrophobic properties of the reaction products of components A and B) can be readily controlled by controlling the type and number of alkyleneoxy groups in component B). For example, the greater the number of ethyleneoxy groups present, the greater the water solubility, while the presence of 1,2-propyleneoxy groups and/or 1,2-butyleneoxy groups for example, will decrease water solubility.

In general, the compounds of formula III wherein the sum of n, m, and p is at least 1, and especially at least 2 are preferred for use herein.

The branched reaction products used in the practice of the invention can be prepared by reacting components A) and B) (and C), if present) together, preferably in the presence of an inert organic solvent, preferably a solvent such as toluene that will azeotrope water, and in the presence of an inorganic base such as an alkali metal hydroxide, e.g. aqueous sodium hydroxide or potassium hydroxide, at a temperature in the range of from 60 to 125° C. In a preferred embodiment of the process, component B)b) is first mixed with the base, and the organic solvent, if present, and water is removed, e.g. by azeotropic distillation. Then component A) (and C), if present) is slowly added and the reaction continued until the reaction is completed. The reaction mixture is filtered and the filtrate vacuum stripped to remove any organic solvent.

Inert organic solvents that can be used in the above process are nonmiscible with water and nonhydroxylic. Examples of such solvents include toluene, CHCl₃, CH₂Cl₂, chlorobenzene, acetonitrile, and petroleum ethers, preferably toluene.

Application methods for applying the nonaqueous compositions of the invention to one or more surfaces of a substrate include the use of air or airless spray equipment; in which the spray application can be electrostatic or nonelectrostatic. With electrostatic spraying, the atomized coating is attracted to the conductive object to be coated by an electrostatic potential between the coating and the object. Very little coating is lost with this process, and irregular objects can be coated uniformly. Heat spray application consists of heating the coating so that it is more fluid and higher-solids coatings can be applied. Two-component spray equipment consists of two material lines to the spray gun so that two materials, e.g. an epoxy and a catalyst, can be mixed in the gun just before application.

Examples of the nonaqueous compositions of the invention formulated for spray application include, but are not limited to, coatings, e.g. solvent-based paints, enamels, varnishes, and lacquers, polyurethane coatings, and phenolic coatings; adhesives and sealants, airplane deicing fluids; finish removers; and chemical processing compositions.

The branched reaction products used in the nonaqueous compositions of the invention are effective defoamers and antifoaming agents in such nonaqueous composition, having rapid foam knockdown, persistent effects, good shelf life, absence of adverse effects on the compositions, ease of handling, low toxicity to manufacturing personnel and users, excellent environmental acceptability, very good cost-effectiveness, very good chemical stability in both acidic and basic composition, and good heat stability.

Solvent-based paints formulated for spraying usually made up of four basic groups of chemical raw material: binders or resins, pigments, solvents, and additives. The term “solvents” used herein means nonaqueous solvents, which are usually hydrocarbon solvents. When a paint is applied to a surface, the solvents begin to evaporate while the binder, pigments, and additives remain on the surface to form a hard, dry solid film. The paint formulator selects the proper type and concentration of raw material from each of these groups that will provide paint with the desired end use properties.

Examples of binders and resins used in solvent-based paints include alkyds, linseed oil, and oil-modified epoxy and polyurethane resins. The types of pigments used include organic and inorganic colored pigments as well as inorganic extenders and filler pigments. Solvent choice is limited mainly to solvent that is compatible with the binder and has the desired evaporation rate and toxicity profile. Additives include thickeners, biocides, driers, pigment dispersants, surfactants, defoamers, and other specialty ingredients used at relatively low levels in a paint formulation.

The branched reaction products used in the spray-formulated solvent-based paint compositions of the invention function as both defoaming/antifoaming agents and low foaming surfactants. They can be used alone as the surfactant component of the paint, or in combination with other surfactants.

The solvent-based paint compositions of the invention have good product uniformity in the container without either pigment settling, phase-separation of the liquids, or color float. The paints also have an acceptable viscosity and rheological profile. The branched reaction products help control the application and rheological properties of the paint.

The paint compositions of the invention include, but are not limited to, exterior and interior house paints, and house paint finishes, such as primers, sealers, and opaque solid stains.

Also included within the scope of the invention are the following nonaqueous spray-formulated compositions:

Enamels, which are types of oil-base paints containing binders that form a film by oxidation or polymerization on exposure to air and which have an outstanding ability to form an especially smooth film. Enamels are usually intended for use as top coats and contain relatively less pigment than paint formulations for priming or surfacing. Enamels consist of an intimate dispersion of pigments in a varnish or resin vehicle. The vehicle may be an oil-resin mix or entirely synthetic resin. Those containing drying oils are converted to films by oxidation; those comprised wholly of synthetic resins may be converted by either heat or oxidation, or both.

Lacquers, which are protective or decorative coatings that dry primarily by evaporation of solvent, rather than by oxidation or polymerization. Lacquers were originally comprised of high-viscosity nitrocellulose, a plasticizer (dibutyl phthalate or brown caster oil), and a solvent. Later, low-viscosity nitrocellulose became available; this was frequently modified with resins such as ester gum or rosin. The solvents used are ethanol, toluene, xylene, and butyl acetate. Together with nitrocellulose, alkyd resins are used to improve durability. The nitrocellulose used for lacquers has a nitrogen content of 11-13.5% and is available in a wide range of viscosities, compatibilities, and solvencies. Chief uses of nitrocellulose-alkyd lacquers are for coatings for metal as well as other products. Various types of modified cellulose are also used as lacquer bases, combined with resins and plasticizers. Many noncellulosic materials, such as dibutyl phthalate, butylbenzyl phthalate, vinyl and acrylic resins are also used, as are bitumens, with or without drying oils, resins, etc.

Baking finishes, which are paints or varnishes that require baking at temperatures greater than 66° C. for the development of desired properties. Such finishes are based on oil-modified alkyd, melamine, epoxy, e.g. epoxy esters, nitrocellulose, or urea resins, or combinations of these. Baking is often done by infrared radiation producing high molecular weight coatings that are dense and tough.

Other solvent-borne coating compositions contain resins such as alkyds (polyester resins made from polybasic acids and polyhydric alcohols), epoxides, polyurethanes, polyesters other than alkyds, and amino crosslinkers which are modified melamines.

Thermosetting acrylic resin based coatings. The acrylic resins are mono- or copolymers of acrylic acid or methacrylic acid esters. Some of the common monomers are methyl methacrylate, butyl methacrylate, methyl acrylate, butyl acrylate, ethyl acrylate, and 2-ethylhexyl acrylate.

Thermosetting acrylic resins have at least one monomer belonging to the acrylic family which will react with itself or other resins at elevated temperatures to crosslink in order to cure. In addition to acrylate monomers previously mentioned, acrylonitrile, acrylamide, styrene, and vinyl toluene are often used in these polymers. Polymers which react to crosslink primarily because of hydroxyl groups are usually combined with an epoxy resin; those which react mainly with carboxyl groups usually are combined with an amine resin. Thermosetting acrylic paints are hard and stain-resistant and have high gloss.

Phenolic coatings, which contain phenolic resins as used in coatings are primarily made from phenol and para-substituted phenols reacted with formaldehyde to form methylol groups on the phenol ring. Condensation polymers are then produced by reacting these groups with phenol. Phenolic coatings are fast drying and have high build and good resistance to moisture and chemicals. Oil-modified phenolaldehyde finishes are sometimes used for aluminum paints.

Polyurethane coatings are based upon reactions of isocyanates. Urethane coatings have excellent solvent and chemical resistance, abrasion resistance, hardness, flexibility, gloss, and electrical properties.

The above coatings containing the above branched reaction product or products, can then be applied to one or more surfaces of a hard substrate to be coated.

Organic finish removers, including paint removers, are usually methylene chloride-containing compositions. The low molar volume of methylene chloride allows it to rapidly penetrate the finish by entering the microvoids of the finish. When the solvent reaches the substrate, the remover releases the adhesive bond between the finish and the substrate and causes the finish to swell. The result is a blistering effect and an efficient rapid lifting action. Larger molecule solvents generally cannot cause this lifting action and must dissolve the finish. When methylene chloride is used in amounts of 78% or more, even with flammable cosolvents, the mixture is nonflammable. A typical methylene chloride base remover includes cosolvents, activators, evaporation retarders, corrosion inhibitors, thickeners, and wetting agents.

Typical cosolvents include methanol, ethanol, isopropyl alcohol, or toluene. The selection of cosolvents depends on the requirement of the formula and their interaction with other ingredients. Methanol is a common cosolvent in methylene chloride formulas since it has good solvency and is needed to swell cellulose-type thickening agents.

Other paint and finish removers include petroleum solvent-based composition such as mineral spirits; blends of acetates and alcohols; and acetone-based, methyl ethyl ketone-based, or toluene-based finish removers.

Drying oils are synthetic or natural oils that oxidize upon exposure to air from a liquid film to a solid, dry film. Most natural drying oils are derived from plant seeds, e.g. linseed oil which is obtained from flaxseed, soybean oil, perilla, safflower, sunflower, walnut oil, tung oil, oiticica oil, dehydrated castor oil, tall oil, marine fish oils, and the like.

Varnishes are solutions of drying oils containing dissolved solid resins, followed by dilution with a hydrocarbon solvent.

Airplane deicing fluids are glycol-based compositions; e.g. ethylene or propylene glycol. Such composition contain corrosion inhibitors to minimize corrosion effects on aircraft metals of construction. Additionally, the fluids must not adversely affect the acrylic and polycarbonates used for aircraft windows by crazing or staining, and should not stain, discolor, or blister painted and unpainted aircraft surfaces. The branched reaction products used in the above deicing fluids, do not adversely affect aircraft windows nor the painted or unpainted aircraft surfaces.

Runway deicing fluids are often glycol-based compositions that contain urea.

With respect to nonaqueous adhesive compositions that are applied by spraying, such adhesive composition are solvent-based adhesives, i.e. formed by a solution of a high molecular weight polymer in a solvent. Solvent-based adhesives are usually elastomeric based.

Other nonaqueous adhesive compositions that can be applied by spraying are so-called structural adhesives formulated from epoxy resins, phenolic resins, acrylic monomers and resins, urethanes, or high temperature-resistant resins such as polyimides.

The invention will be illustrated but not limited by the following examples.

### EXAMPLES

### Example 1

### Preparation of the Reaction Product of Decyl Alcohol.4EO and Epichlorohydrin

About 150 grams of decyl alcohol ethoxylated with an average of 4 moles of ethylene oxide (0.45 OH equivalents) were mixed with 385 grams of toluene and 54 grams of 50% aq. NaOH (0.675 equivalents). The water was removed by azeotropic distillation and when a moisture level of less than 0.8% was reached, about 46 grams (0.51 equivalents) of epichlorohydrin were slowly added. This mixture was allowed to react at 100°-110° C. for 24 hours. An aliquot of this mixture was removed and filtered to remove the NaCl and vacuum stripped to remove the toluene to give an amber, easily pourable liquid product.

### Example 2

An exterior alkyd-linseed oil flat solvent-based house paint is prepared from the raw material ingredients shown in Table 1 below:

TABLE 1

| | |
|---|---|
| Raw material ingredients | Weight, kg |

Grind portion

| | |
|---|---|
| mineral spirits | 76.3 |
| clay thickener | 18.5 |
| Mildecide | 13.5 |
| alkyd resin, 60% | 186.7 |
| reaction product of example 1 | 12.8 |
| titanium dioxide | 321.0 |
| extenders | 319.3 |

Let-down portion

| | |
|---|---|
| alkyd resin, 60% | 166.3 |
| linseed oil, 80% | 119.9 |
| mineral spirits | 121.7 |
| organometallic driers | 6.0 |
| antiskinning agents | 1.8 |

The above paint composition is then applied with airless spray equipment to a wood-sided house. The paint coating when dry is smooth, uniform, and without any fish-eyes or other blemishes.

### Example 3

### Preparation of the Reaction Product of Octyl Alcohol.4EO and Epichlorohydrin

About 200.0 gm (0.654 hydroxyl equivs.) of octyl alcohol ethoxylated with an average of 4 moles of ethylene oxide was mixed with 400 gm toluene and 78.4 gm (0.98 equivs.) of 50% NaOH. Water was removed by azeotropic distillation until the level was below 0.8%. The mixture was cooled to 80° C. and 67.2 gm (0.72 moles) of epichlorohydrin was added over 45 mins. The mixture was stirred for 24 hrs at 110° C. until the epoxy titration showed no epoxide left. The material was cooled, filtered and the toluene was removed by vacuum distillation leaving a dark brown low viscosity liquid.

### Example 4

A deicing fluid for deicing aircraft is prepared from 96% by weight propylene glycol, 2% by weight of corrosion inhibitors, and 2% by weight of the branched reaction product of Example 3.

The above composition, when sprayed on iced aircraft, effectively removes the ice and snow coatings, without harming the aircraft metal components or the plastic window components.

What is claimed is:

1. In a nonaqueous composition formulated to be applied to a substrate by spray application, the improvement wherein the composition contains a foam-reducing quantity of at least one base-catalyzed reaction product comprising the following reactants:
A) at least one compound of formula I
R¹(X)₃ (I)
wherein each X group is a halogen atom or one X group is a halogen atom and two X groups represent an epoxy oxygen atom, which is attached to two adjacent carbon atoms in the R¹ group to form an epoxy group, and R¹ is an alkanetriyl group containing from 3 to 10 carbon atoms; and
B) at least one compound having the formula II R²X(AO)ₙY (II)
wherein R² is a substituted or unsubstituted, saturated or unsaturated, organic group having from 1 to 36 carbon atoms; X is —O—, —S—, or —NR³— where R³ is hydrogen or a C₁-C₁₈ alkyl group; each AO group is independently an ethyleneoxy, 1,2-propyleneoxy, or 1,2-butyleneoxy group, n is a number of from 0 to 200; and Y is hydrogen, or Y can be a mercapto group or an amino group or a C₁-C₆ alkylamino group in place of a terminal —OH group, provided that when Y is mercapto or an amino group or a C₁-C₆ alkylamino group, n is at least 1;
wherein the mole ratio of the linking compound A) to B) is from 0.1:1 to 5:1.

2. The composition of claim 1 wherein said mole ratio is from about 0.6:1 to about 2:1.

3. The composition of claim 1 wherein said mole ratio is from about 0.8:1 to about 1.5:1.

4. The composition of claim 1 wherein the composition contains from about 0.001 to 5% by weight of the at least one base-catalyzed reaction product.

5. The composition of claim 1 wherein the composition contains from about 0.1 to 3% by weight of the at least one base-catalyzed reaction product.

6. The composition of claim 1 wherein component A) in said reaction product is epichlorohydrin.

7. The composition of claim 1 wherein in formula II in said reaction product n is a number of from 1 to 100.

8. The composition of claim 7 wherein n is a number of from 2 to 20.

9. The composition of claim 1 wherein in component B) in said reaction product the R² group is a straight or branched chain alkyl group.

10. The composition of claim 9 wherein in component B) n is a number of from 2 to 20.

11. The composition of claim 1 wherein component B) in said reaction product has the formula:
R²O(EO)ₘ(PO)ₚ(BO)_{q}H (III)
wherein R² has the meaning given in claim 1, m is a number of from 0 to 100, p is a number of from 0 to 50, and q is a number of from 0 to 50.

12. The composition of claim 10 wherein component A) in said reaction product is epichlorohydrin.

13. The composition of claim 11 wherein the mole ratio of component A) to component B) is from about 0.6:1 to 2:1.

14. The composition of claim 13 wherein said mole ratio is from about 1.0:1 to about 2:1

15. The composition of claim 13 wherein said mole ratio is from about 0.8: to about 1.5:1.

16. The composition of claim 1 1 wherein m is a number of from 2 to 20.

17. The composition of claim 16 wherein p and q=0.

18. The composition of claim 11 wherein R² is an alkyl group having from 4 to 12 carbon atoms.

19. The composition of claim 18 wherein R² is a branched alkyl group.

20. The composition of claim 11 wherein R² is an alkyl group having from 4 to 12 carbon atoms, m is a number of from 4 to 50, and p and q=0.

21. The composition of claim 20 wherein component B) is isodecyl alcohol.4EO.

22. A nonaqueous composition formulated to be applied to a substrate by spray application comprising.
I) at least one nonaqueous composition; and
II) at least one base-catalyzed reaction product comprising the following reactants:
A) at least one compound of formula I
R¹(X)₃ (1)
wherein each X group is a halogen atom or one X group is a halogen atom and two X groups represent an epoxy oxygen atom, which is attached to two adjacent carbon atoms in the R¹ group to form an epoxy group, and R¹ is an alkanetriyl group containing from 3 to 10 carbon atoms; and
B) at least one compound having the formula II
R²X(AO)ₙY (II)
wherein R² is a substituted or unsubstituted, saturated or unsaturated, organic group having from 1 to 36 carbon atoms; X is —O—, —S—, or —NR³— where R³ is hydrogen or a C₁-C₁₈ alkyl group; each AO group is independently an ethyleneoxy, 1,2-propyleneoxy, or 1,2-butyleneoxy group, n is a number of from 0 to 200; and Y is hydrogen, or Y can be a mercapto group or an amino group or a C₁-C₆ alkylamino group in place of a terminal —OH group, provided that when Y is mercapto or an amino group or a C₁-C₆ alkylamino group, n is at least 1;
wherein the mole ratio of the linking compound A) to B) is from 0.1:1 to 5:1.

23. The composition of claim 22 wherein said mole ratio is from about 0.6:1 to about 2:1.

24. The composition of claim 22 wherein said mole ratio is from about 0.8:1 to about 1.5:1.

25. The composition of claim 22 wherein the composition contains from about 0.1 to 3% by weight of the at least one base-catalyzed reaction product.

26. The composition of claim 22 wherein component A) in said reaction product is epichlorohydrin.

27. The composition of claim 22 wherein in formula II in said reaction product n is a number of from 1 to 100.

28. The composition of claim 27 wherein n is a number of from 2 to 20.

29. The composition of claim 22 wherein in component B) in said reaction product the R² group is a straight or branched chain alkyl group.

30. The composition of claim 29 wherein in component B) n is a number from 2 to 20.

31. The composition of claim 1 wherein component B) in said reaction product has the formula
R²O(EO)ₘ(PO)ₚ(BO)_{q}H (III)
wherein R² has the meaning given in claim 1, m is a number of from 0 to 100, p is a number of from 0 to 50, and q is a number of from 0 to 50.

32. The composition of claim 31 wherein component A) in said reaction product is epichlorohydrin.

33. The composition of claim 31 wherein the mole ratio of component A) to component B) is from about 0.1:1 to about 5:1.

34. The composition of claim 33 wherein said mole ratio is from about 0.6:1 to about 2:1.

35. The composition of claim 33 wherein said mole ratio is from about 0.8:1 to about 1.5:1.

36. The composition of claim 31 wherein m is a number of from 2 to 20.

37. The composition of claim 36 wherein p and q=0.

38. The composition of claim 31 wherein R² is an alkyl group having from 4 to 12 carbon atoms.

39. The composition of claim 38 wherein R² is a branched alkyl group.

40. The composition of claim 31 wherein R² is an alkyl group having form 4 to 12 carbon atoms, m is a number of from 4 to 50, and p and q=0.

41. The composition of claim 40 wherein component B) is isodecyl alcohol.4EO.

42. The composition of claim 1 wherein the composition is a nonaqueous solvent-based paint.

43. The composition of claim 1 wherein the composition is selected from the group consisting of a varnish, a lacquer, and an enamel.

44. In a method for spraying a nonaqueous composition onto a substrate, the improvement wherein the nonaqueous composition contains a foam reducing quantity of at least one base-catalyzed reaction product comprising the following reactants:
A) at least one compound of formula I
R¹(X)₃ (1)
wherein each X group is a halogen atom or one X group is a halogen atom and two X groups represent an epoxy oxygen atom, which is attached to two adjacent carbon atoms in the R¹ group to form an epoxy group, and R¹ is an alkanetriyl group containing from 3 to 10 carbon atoms; and
B) at least one compound having the formula II
R²X(AO)ₙY (II)
wherein R² is a substituted or unsubstituted, saturated or unsaturated, organic group having from 1 to 36 carbon atoms; X is —O—, —S—, or —NR³— where R³ is hydrogen or a C₁-C₁₈ alkyl group; each AO group is independently an ethyleneoxy, 1,2-propyleneoxy, or 1,2-butyleneoxy group, n is a number of from 0 to 200; and Y is hydrogen, or Y can be a mercapto group or an amino group or a C₁-C₆ alkylamino group in place of a terminal —OH group, provided that when Y is mercapto or an amino group or a C₁-C₆ alkylamino group, n is at least 1;
wherein the mole ratio of the linking compound A) to B) is from 0.1:1 to 5:1.
